(19) United States
(12) Patent Application Publication
(10) Pub. No.: US 2010/0245816 A1
(43) Pub. Date: Sep. 30, 2010

(54) Near-field Raman spectroscopy

(75) Inventors: Zexiang Shen, Singapore (SG); Johnson Kasim, Singapore (SG); Yumeng You, Singapore (SG); Ting Yu, Singapore (SG)

Correspondence Address: OLIFF & BERRIDGE, PLC, P.O. BOX 320850, ALEXANDRIA, VA, 22320-4850, US

(73) Assignee: RENISHAW PLC, WOTTON-UNDER-EDGE (GB)

(21) Appl. No.: 12/660,000

(22) Filed: Mar. 26, 2010

Related U.S. Application Data
(60) Provisional application No. 61/202,698, filed on Mar. 27, 2009.

(51) Int. Cl. G01J 3/44

(52) U.S. Cl. 356/301

(57) ABSTRACT

Near-field Raman imaging is performed by holding a dielectric microsphere (e.g. of polystyrene) on or just above the surface of a sample in a Raman microscope. An illuminating laser beam is focused by the microsphere so as to produce a near-field interaction with the sample. Raman scattered light at shifted wavelengths is collected and analysed. The microsphere may be mounted on a cantilever of an atomic force microscope or other scanning probe microscope, which provides feedback to hold it in position relative to the sample surface. Alternatively, the microsphere may be held on the sample surface by an optical tweezer effect of the illuminating laser beam.

### CROSS-REFERENCE TO RELATED APPLICATION

This application claims priority from U.S. Provisional Patent Application No. 61/202,698, filed 27 Mar. 2009, which is incorporated herein by reference.

### FIELD OF THE INVENTION

This invention relates to spectroscopy, for example spectroscopy using Raman, photoluminescence (PL) or other inelastically scattered light. It also relates to microscopy using near-field effects.

### DESCRIPTION OF PRIOR ART

Raman and photoluminescence (PL) microscopy (Raman microscopy for short) has been used extensively for material characterization in research and industry. They are examples of spectroscopic techniques using light which is inelastically scattered by the sample. These techniques provide information on the composition, chemical bonding, electronic and atomic structures and strain/stress of the sample. This information cannot be obtained/or easily obtainable by other conventional microscopic techniques such as atomic force microscopy (AFM), scanning electron microscopy (SEM), transmission electron microscopy (TEM), and confocal optical microscopy. Raman microscopy is also a technique that is non-destructive and sample preparation free, unlike some of the techniques listed above which require extensive sample preparation and are destructive. Hence Raman microscopy is a very useful technique, complementary to the existing techniques.

The main stumbling block for the application of Raman microscopy in nano-science and nano-technology has been the relatively large laser focus point on the sample, which is determined by the diffraction limit of light waves, at ˜λ/2, where λ is the wavelength of the laser light used, which is typically 500 nm. This gives a theoretical laser focus spot size (and hence theoretical spatial resolution of the technique) of about 250 nm. In practice, the spatial resolution is in the order of λ.

Several techniques have been employed to improve the resolution by utilizing near-field techniques. Among them, the most frequently used near-field Raman techniques are laser light delivered through a metal-coated tapered optical fiber (aperture) (Grausem et al, “Near-field Raman spectroscopy”, J. Raman Spectrosc. 30, 833-840 (1999)) and tip-enhanced (apertureless) techniques (Shen and Sun, U.S. Pat. No. 6,643,012 and “Near-field scanning Raman microscopy using apertureless probes”, J. Raman Spectrosc. 34, 668-676 (2003)).

In the aperture technique, a small aperture (50-100 nm) is used to deliver the laser light to the sample surface. Because of the weak optical transmission of excitation light through the aperture, the Raman signal obtained is extremely weak (low signal to noise ratio SNR), resulting from the small Raman scattering cross-section. As a result, it requires extremely long imaging time (e.g. 10 hours), making Raman imaging impractical. In fact, it is too long even for the most stable Raman spectrometer in the market.

In the apertureless technique, which is also known as tip-enhanced Raman spectroscopy (TERS), a sharp metal tip or metal-coated tip is used, in which a laser spot focused on the tip apex creates a strongly confined optical field. This technique is the preferred choice for performing near-field Raman imaging (NFRM) due to the strong Raman intensity compared to the aperture technique. Spatial resolution about 10 nm has been achieved. However, to obtain repeatable high-resolution images is a challenge due to the difficulty in controlling the geometry of the metal tip which is in nanometer scale. When it is working, the technique only works for a few selected samples which do not include some of the most technologically important materials, e.g. Si and Ge. Besides that, this approach also faces wear-tear and oxidation problems. Another problem is the laser spot focused on the tip apex causes an intense background (far-field signal with low spatial resolution) that should be eliminated to achieve a better SNR. As a result, this technique has very low success rate and it is not commonly used as a routine characterization technique.

Another approach in improving optical resolution is by using a solid immersion lens (SIL). Birkbeck et al “Laser tweezer controlled SIL microscopy in microfluidic systems”, Opt. Lett. 30, 2712-2714 (2005) used a trapped polystyrene SIL for optical imaging. The size of the SIL is 10 μm (excitation laser is 488 nm). They observed an enhancement in magnification and resolution of their sample using SIL. But it is important to note that the resolution was not sub-diffraction limit resolution. No Raman imaging has ever been performed using this technique. Furthermore, a hemispherical SIL has a flat surface in contact with the surface of the sample. This is difficult to drag over the sample surface to perform scanning to build up a two-dimensional image, and the surface can be damaged as a result. And if the surface is not flat but has structure, then the device may not operate in the near field.

### SUMMARY OF THE INVENTION

According to the present invention, a spectroscopic apparatus for examining a sample comprises:
a light source having an illuminating wavelength;
a micro-particle, arranged to be illuminated by the light source and to be held on or just above a surface of the sample so as to interact with a sub-diffraction limit area of the sample; and
a spectroscopic analyser which receives and detects light scattered from the sub-diffraction limit area at wavelengths different from the illuminating wavelength.

The micro-particle is preferably a microsphere, and preferably is made of a dielectric material. A preferred dielectric material is polystyrene, but other materials such as silica or polymethyl methacrylate (PMMA) are possible.

In one preferred embodiment, the micro-particle is held on or just above the surface by an optical trapping or “optical tweezer” technique. We have found that the spatial resolution obtained using this technique in the preferred embodiment is about 100 nm, much smaller than that obtained by SIL.

This technique has the drawback that there is Brownian motion that can lower the resolution. Also, the preferred embodiment traps the micro-particle in a liquid, preferably water, and so it cannot be used for water sensitive samples.

In another preferred embodiment, therefore, the micro-particle is mounted on a member such as a cantilever. This may hold the micro-particle on or just above the surface of the sample using similar feedback techniques to those used in a scanning probe microscope, such as an atomic force microscope. Indeed, in one embodiment, it is possible to carry out scanning probe microscopy such as atomic force microscopy measurements simultaneously with spectroscopic measurements.

### BRIEF DESCRIPTION OF THE DRAWINGS

FIG. 1 is a schematic block diagram of a first embodiment of spectroscopic apparatus, in which an inset (b) is an enlarged view of part of the apparatus shown at (a);

FIG. 2 is a schematic block diagram of a second embodiment of spectroscopic apparatus;

FIG. 3 shows side, bottom, front and top views of a modified AFM cantilever used in the embodiment of FIG. 2;

FIG. 4 is a schematic diagram of a feedback system of the embodiment of FIG. 2; and

FIG. 5 shows an alternative modified AFM cantilever for use in the embodiment of FIGS. 2 and 4.

### DESCRIPTION OF PREFERRED EMBODIMENTS

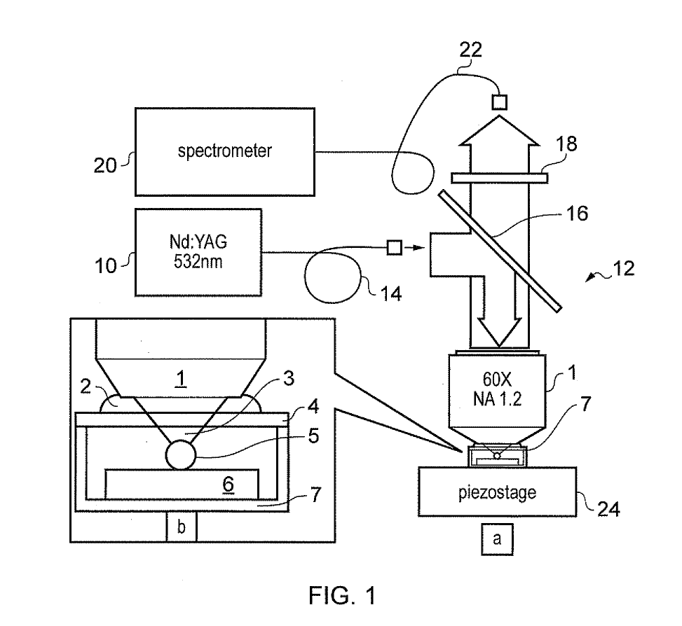

We have developed a new approach to near field, whereby the laser is focused to a spot size smaller than diffraction limit by a dielectric microsphere. In the embodiment of FIG. 1, besides being used as the excitation source for Raman spectroscopy, the incident laser beam (linearly polarized Gaussian TEM₀₀ mode) is also used to hold the microsphere just above the sample surface, through the well-known optical tweezer mechanism. See Ashkin, A., “Applications of laser radiation pressure”, Science 210, 1081-1088 (1980) and Ashkin, A. “Optical trapping and manipulation of neutral particles using lasers”, Proc. Natl. Acad. Sci. USA 94, 4853-4860 (1997).

The diameter of the dielectric microsphere is comparable to the wavelength of the laser. Simulation studies have shown that sub-diffraction limited focusing can thereby be achieved, with improved spatial resolution due to the near field effect. See Xu Li et al, “Optical analysis of nanoparticles via enhanced backscattering facilitated by 3D photonic nanojets”, Opt. Express 13, 526-533 (2005).

In our experiment in accordance with the embodiment of FIG. 1, the sample 6 and a few polystyrene dielectric microspheres (e.g. 3 μm in diameter, purchased from Polysciences Inc.) in solution were placed in a sample cell 7 filled with liquid (normally de-ionized water). One microsphere 5 was trapped at the center of the laser beam and was in contact with the surface of the sample during scanning. Other materials could be used as the dielectric instead of polystyrene, e.g. silica or polymethyl methacrylate (PMMA).

The sample cell 7 is covered using a thin cover glass 4. The sample cell is placed on the scanning stage of a confocal Raman microscope 12, e.g. the WITec CRM200 model with 25 μm confocal pinhole. In this example, illuminating light from a laser 10 enters the microscope 12 via a 3.5 μm core diameter single-mode optical fiber 14. It is reflected towards the sample by a beamsplitter 16, and then focused at 3 on the sample 6 through an objective lens 1 of the microscope and through the microsphere 5. The lens 1 is preferably a water immersion lens with water 2 between it and the cover glass 4.

Raman, PL or other inelastically scattered light with a shifted wavelength is excited in the sample as a result of near-field illumination through the microsphere. It is collected from the sample by the objective lens 1 and passed back through the beamsplitter 16. An edge or notch filter 18 rejects light scattered elastically at the laser wavelength. The inelastically scattered light is then taken to a spectrometer 20 or other spectroscopic analyser for analysis, e.g. via a multi-mode optical fiber 22. Such arrangements are well known, and for example the beamsplitter itself could be a notch or edge filter which accepts the inelastically scattered light and rejects the elastically scattered light.

In our experiments, by way of example, an Nd:YAG laser 10 with an illuminating wavelength of 532 nm is used. An objective lens (e.g. Nikon 100×NA0.9 or Olympus 60×NA1.2) is used to focus the laser using backscattering configuration. The size of the trapped dielectric microsphere is preferably 0.5 μm to 10 μm, more preferably 0.5 μm to 3 μm. Thus, the size of the microsphere 5 is comparable to (i.e. of the same order of magnitude as) the illuminating wavelength. The sample cell is placed on a piezoelectric stage 24 that can be scanned over a travel distance of 100 μm in x- and y-axes and 20 μm in the z-direction, in nanometer precision to enable mapping of the surface of the sample. This stage 24 may in turn be placed on a coarse x-y translation stage (not shown). The Raman or other inelastically scattered signal is collected back by the same objective lens and detected in the spectrometer by a thermoelectrically-cooled CCD. The microsphere in solution is trapped and pushed down onto the sample surface by the laser. Hence the microsphere is in contact with the surface of the sample during scanning.

Thus, in summary, the focused laser light that is used to excite Raman, photoluminescence or other inelastically scattered signal, is also used to trap a microsphere 5 as shown in FIG. 1. Now the laser light is incident on the sample through the microsphere. In the microsphere 5, light is focused on the sample 6 as an evanescent field by the near-field effect, below the diffraction limit. This may result from total internal reflection, for example. There is no far-field signal in our setup, which has been one of the major problems in TERS. Equally important, the Raman signal collected with microsphere using our technique is always much stronger than that without the microsphere, by 2-5 times depending on the objective lens used. This is another critical advantage over other near-field techniques. The strong near-field Raman signal in our setup makes Raman imaging much easier and faster. The reproducibility of the results is excellent, at near 100% level.

During mapping, either the sample is scanned (using the piezoelectric stage) or the laser beam is scanned. In either scanning mode, the microsphere is firmly anchored at the center of the laser beam by the optical tweezer (optical trapping) mechanism.

This technique is very useful for characterization of nano-materials and nano-devices. We can achieve sub-diffraction resolution about 80 nm at present. Positioning the microsphere in solution by optical tweezer removes the requirement for scanning probe mechanism, which is a necessary requirement for other near-field techniques. With normal confocal microscopy system, this technique can be performed easily; the ends of the fibers 14, 22 act as confocal apertures in conjunction with the lens 1.

Strain/stress analysis/measurement in semiconductor device is critically important for the wafer fabrication industry. Too much strain causes failure of the device. On the other hand, strain engineering can also be used to improve the performance of the device. We have shown the capability of this technique to study the strain/stress on the device with ˜100 nm resolution. This is the only Raman mapping of such a device to date.

To test the spatial resolution of our near-field Raman system, we have studied a SiGe/Si device structure with 45 mm poly-Si gate length and SiGe stressors. The patterned wafers used in this study were prepared using 65 nm device technology. After spacer formation and Si recess etch, the wafers were cleaned and epitaxial SiGe growth was performed on a commercially available LPCVD system. We have also shown the capability of our technique in studying the strain on the channel below the poly-Si gates, which is compressively strained by the SiGe stressors.

Straining silicon can change the band structure and mobility of carriers in semiconductor device. Semiconductor industry has used mechanical strain as an alternative to physical scaling in improving the transistor performance. Appropriate strain applied to the channel region can significantly improve transistor performance. However, in complementary metal-oxide-semiconductor (CMOS) transistor, n-MOS and p-MOS need to be strained differently. Compressive strain is known to be beneficial for p-MOS, but it will degrade the n-MOS performance. Tensile strain is known to improve the n-MOS performance, but it will degrade the p-MOS performance. That is why a technique to characterize strain with sub-100 nm resolution reliably is high in demand.

Micro-Raman spectroscopy has been a popular tool for strain measurements because it is non-destructive and quantitative. Compressive strain shifts the Raman peak to higher frequency, while the tensile strain result in a red shift. However, the spatial resolution of micro-Raman makes it impossible to be used for strain characterization in sub-100 nm semiconductor devices. At the moment, converging beam electron diffraction (CBED) in transmission electron microscopy (TEM) is used to characterize the strain locally. Destructive and complicated sample preparations have made this technique undesirable for large-scale strain characterization. Hence, reliable non-destructive quantitative assessment of strain in nanometer scale is critical. However, there is no such characterization technique available in the market. Using our technique, we have shown the first strain measurement down to 45 nm lines with much improved repeatability and SNR. Furthermore, since our technique produces high signal levels it enables fast scanning so that samples may be scanned in a reasonable time, e.g. a few minutes.

In conclusion, FIG. 1 shows a new design in performing high-resolution near-field Raman imaging with a spatial resolution of about 65 nm. High-resolution Raman image of semiconductor device was obtained by scanning a 3 μm or less diameter polystyrene microsphere using optical tweezer mechanism. The microsphere is used to focus the excitation laser, and also to collect the scattered Raman signal. The major advantages of this technique are non-destructive, high reproducibility (almost 100%), fast (strong signal), no far-field background, and easy to use compared to other near-field Raman techniques, e.g aperture and apertureless methods. We also showed the capability of this technique in studying the strain on sub-100 nm semiconductor device, in which Si channel is compressively strained by SiGe stressors. High-resolution Raman imaging is critically important for a wide range of applications, including the study of Si devices, nanostructures/materials, quantum dots, and single molecules of biological samples. No other technique can provide the same information non-destructively.

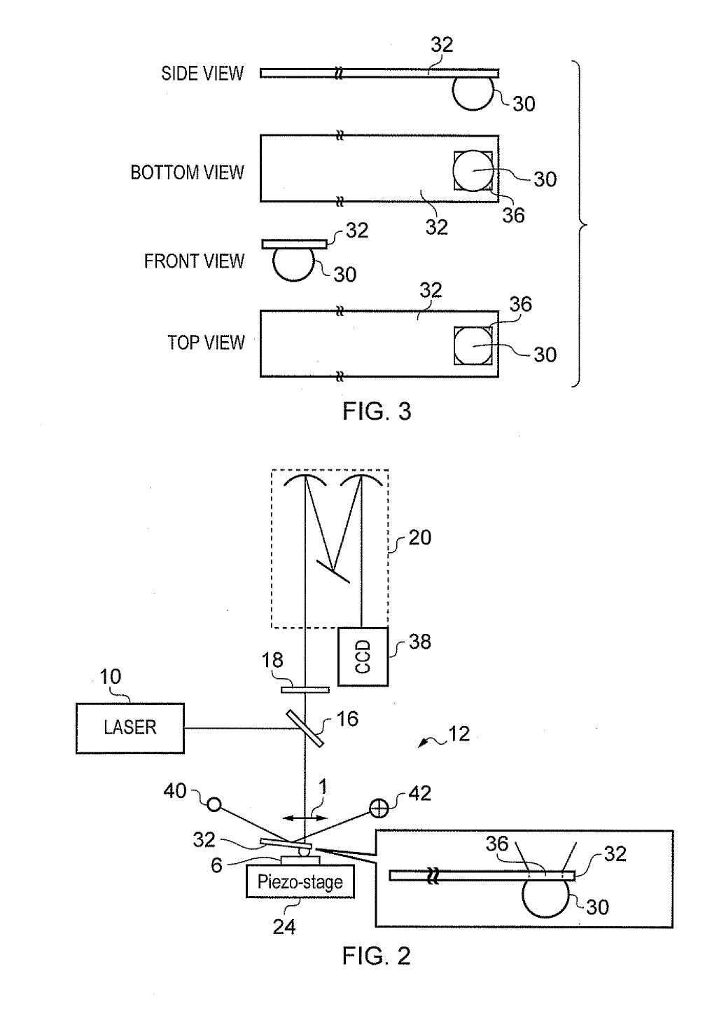

FIGS. 2-4 show another preferred embodiment which eliminates the requirement of a liquid cell.

In FIGS. 2-4, a dielectric microsphere 30 (e.g. polystyrene, PMMA or silica) is attached to a modified atomic force microscopy (AFM) cantilever 32 (e.g. of silicon). This is used to hold and position the microsphere over a point of interest in a sample 6 in order to perform near-field Raman imaging as in FIG. 1.

The cantilever is mounted by a mount 34 in a Raman microscope 12 similar to that of FIG. 1. The same reference numbers have been used for similar components, and their description will therefore not be repeated. Of course, some details may be different from FIG. 1 as appropriate, e.g. it would be difficult or impossible to use an immersion lens with the cantilever.

The dielectric microsphere 30 is attached in an aperture 36 of the modified AFM probe, as shown in the FIG. 3. The focused laser light is used to excite Raman, photoluminescence or other inelastically scattered signal with a shifted wavelength. Now the laser light is incident on the sample through the aperture on the AFM probe, then to the microsphere, resulting in the near-field and hence increased spatial resolution. During mapping, either the sample is scanned on x- and y-axes using a piezoelectric stage 24, or the laser beam and the cantilever are scanned together on x- and y-axes (e.g. with a laser scanning system synchronized to movement of the cantilever tip). Scanning the sample is preferred, with the laser and cantilever maintaining a constant position, to avoid the need for cantilever movement to track the laser scanning. In either scanning mode, the microsphere is firmly attached to the AFM cantilever. The microsphere may be in contact with the surface of the sample while scanning. As previously, the Raman signal from the sample is collected back in the backscattering configuration and detected by a thermoelectrically-cooled CCD 38 in a spectrometer 20.

The AFM technique may use feedback from mechanical contact force, Van der Waals forces, capillary forces, chemical bonding, electrostatic forces, magnetic forces etc. Such forces deflect the cantilever towards or away from the surface of the sample. This is detected by a detector 42, such as a 4-quadrant photodetector, which receives a light beam reflected off the cantilever from a light source 40 such as a laser diode.

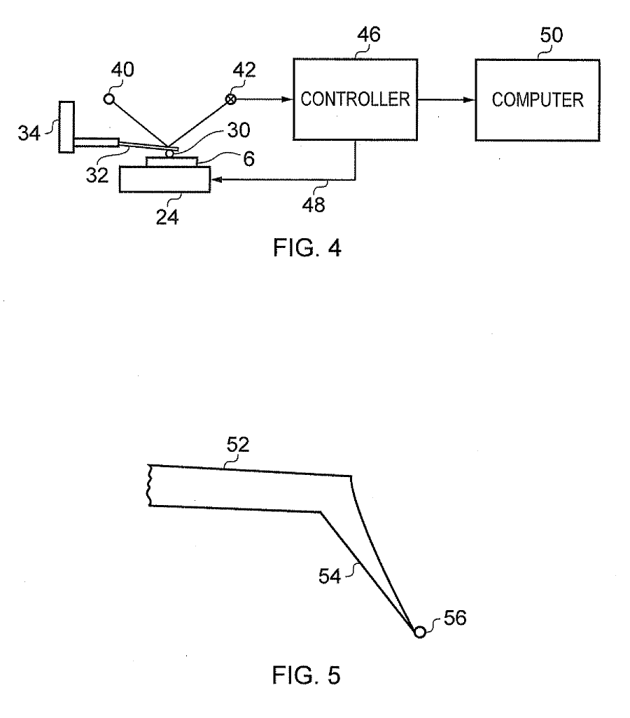

As shown in FIG. 4, the signal from the detector 42 is processed by a controller 46 and fed back via a line 48 to control the z-axis movement of the piezoelectric stage 24. This keeps the position of the cantilever constant relative to the sample such that the microsphere is maintained in the near-field regime.

This embodiment can be applied for a wide range of applications in imaging. It is also possible to carry out atomic force microscopy measurement simultaneously, by a computer 50 which acquires reading from the controller 46.

Many other types of scanning probe microscopy are known and may be used in place of AFM, including scanning tunnelling microscopy, scanning thermal microscopy, scanning microscopies using electric or magnetic effects, resonance effects, etc. In these cases, the microsphere 30 will be attached to the scanning probe in whatever form it takes; an AFM cantilever is not essential.

Surprisingly, we have found that it is not essential for the microsphere to be in contact with the sample surface. A quasi-near field effect (with sub-diffraction limit resolution) may still be obtained even when the AFM technique holds the microsphere out of contact above the sample surface, outside the normal range of the evanescent field.

In the present embodiment of our invention, a new near-field Raman microscopy technique is developed by using microsphere which is attached to AFM cantilever. AFM cantilever is used to hold the microsphere so that characterization/mapping of certain area is possible. Intensity of the Raman signal obtained is stronger than conventional methods. Hence, Raman mapping can be done faster. By using this technique, spatial resolution less than 100 nm can be achieved with high reproducibility.

FIG. 5 shows a further embodiment in which a dielectric microsphere is mounted on an AFM cantilever. It is used as an alternative to the cantilever of FIG. 3, in systems as described in relation to FIGS. 2 and 4.

An AFM cantilever 52 is used, which is commercially available from Nanosensors, Rue Jaquet-Droz 1, Case Postale 216, CH-2002 Neuchatel, Switzerland under the designation ATEC or AdvancedTEC. This has an angled tip 54 which protrudes from the end of the cantilever, so it is accessible to the laser beam.

The commercially available cantilever 52, 54 is modified by attaching a dielectric microsphere 56 to the very end of the protruding tip 54. As in the previous embodiments, the microsphere 56 may for example be of polystyrene, PMMA or silica. It may be attached to the tip 54 by a suitable glue, for example.

The microsphere 56 is attached to the angled tip 54 on the side facing away from the main body of the cantilever 52. The laser beam (FIG. 2) can therefore be focused on the sample by the microsphere without obstruction, resulting in the near-field effect and hence increased spatial resolution as in FIGS. 2-4. Thus, this achieves a similar result to the focusing of the laser beam by the microsphere through the aperture 36 in FIG. 3.

Several features make the techniques of the described embodiments, FIG. 1, FIGS. 2-4 and FIG. 5, very useful for characterization of nano-materials and nano-devices.
1. The near-field Raman signal obtained this way is pure near-field without far-field. And the near-field signal is extremely strong, typically 3-6 times stronger than the corresponding far-field signal. Typical near-field signal using other near-field techniques is much weaker than the far-field for a bulk sample, and both near- and far-field signals co-exist. As far-field signal carries information that is space-averaged, its presence diminishes the usefulness of the near-field technique. Hence the absence of far-field signal in our technique is a major advantage in the development of near-field applications. Strong signal gives a very good S/N ratio compare to other techniques, and experiment time can be significantly shortened. This can overcome the problem faced by the aperture and apertureless techniques, in which drift problem occurs due to long experimental time.
2. The strength of our near-field signal makes near-field Raman mapping even easier and faster than far-field mapping.
3. We are confident that the success rate of obtaining near-field signal and repeatability are nearly 100%, while the success rate and repeatability for other near-field mapping techniques are small. Our technique can be easily adopted for industrial applications.
4. With this technique, we are able to obtain sub-diffraction limit resolution. This resolution is extremely useful for application in nano-devices, e.g. Si devices. Less than 100 nm resolution is expected from this technique.
5. As this technique does not rely on tip-enhancement, it can be applied to study any samples, not limited to the few that shows strong tip-enhanced Raman scattering (TERS) signal. Using this technique, we have already mapped 65 nm SiGe/Si source/drain IC device structure. This is the only Raman mapping of such IC device up to date. Other mapping results which can be performed include: carbon nanotubes, ZnO micro disk, ZnO nano wires and other nano materials, gold nano spheres and CV coated Au nano spheres.
6. By performing the experiment in solution, the FIG. 1 technique has the possibility to perform high resolution imaging on biological samples.

Our technique can be implemented easily and provides a reliable way to perform nano-characterization. This technique can also be implemented in high-resolution optical spectroscopy and imaging as listed below.

(1) Instrumentation: 1. Confocal optical microscopy
2. Raman microscopy
3. PL microscopy
4. Nano optical lithography
   (2) Applications: 1. Single molecule spectroscopy
2. Bio nano-imaging
3. Composition, structural and strain study of nano-devices
4. PL and Raman study of quantum dots and nano-crystals
5. Composition and strain study of semiconductor devices by Raman mapping.

There is a market demand of a tool to study the strain/stress on semiconductor devices efficiently and accurately. Strain/stress in device is very important, as too much strain will cause failure of the device and strain engineering can also be used to improve the performance of the device. There are a few techniques to study the strain/stress of the device, e.g. TEM (CBED), X-Ray Diffraction (XRD), to name a few. However, TEM needs cutting of sample, which will change the strain/stress of the sample; and the resolution of XRD is not suitable for semiconductor device, which is getting smaller and smaller (90 nm or smaller). So one application of the embodiments of this invention aims to study the strain/stress on devices efficiently and accurately.

We claim:

1. A spectroscopic apparatus for examining a sample comprising:
a light source having an illuminating wavelength and producing a light beam;
a micro-particle illuminated by the light beam, the micro-particle being held on or just above a surface of the sample and focusing the light beam to cause a near-field effect in which the light beam interacts with a sub-diffraction limit area of the sample; and
a spectroscopic analyser which receives and detects light scattered from the sub-diffraction limit area at wavelengths different from the illuminating wavelength.

2. A spectroscopic apparatus according to claim 1 wherein the micro-particle is mounted on a probe of a scanning probe microscope, having a feedback system configured to maintain the relative position of the micro-particle and the sample.

3. A spectroscopic apparatus according to claim 1 wherein the micro-particle is mounted on a cantilever of an atomic force microscope having a feedback system configured to, maintain the relative position of the micro-particle and the sample.

4. A spectroscopic apparatus according to claim 1 wherein the micro-particle is mounted on a cantilever.

5. A spectroscopic apparatus according to claim 1 wherein the light beam is configured to produce an optical tweezer effect which holds the micro-particle relative to the sample surface.

6. A spectroscopic apparatus according to claim 1 wherein the micro-particle has a size which is of the same order of magnitude as the illuminating wavelength.

7. A spectroscopic apparatus according to claim 1 wherein the micro-particle is a microsphere.

8. A spectroscopic apparatus according to claim 1 wherein the micro-particle comprises a dielectric material.

9. A spectroscopic apparatus according to claim 8 wherein the dielectric material is polystyrene.

10. A spectroscopic apparatus according to claim 8 wherein the dielectric material is polymethyl methacrylate.

11. A spectroscopic apparatus according to claim 8 wherein the dielectric material is silica.

12. A spectroscopic apparatus for examining a sample comprising:
a light source having an illuminating wavelength;
a micro-particle, arranged to be illuminated by the light source and to be held on or just above a surface of the sample so as to interact with a sub-diffraction limit area of the sample; and
a spectroscopic analyser which receives and detects light scattered from the sub-diffraction limit area at wavelengths different from the illuminating wavelength.

13. A spectroscopic apparatus according to claim 12 wherein the micro-particle is mounted on a probe of a scanning probe microscope, having a feedback system configured to maintain the relative position of the micro-particle and the sample.

14. A spectroscopic apparatus according to claim 12 wherein the micro-particle is mounted on a cantilever of an atomic force microscope having a feedback system configured to maintain the relative position of the micro-particle and the sample.

15. A spectroscopic apparatus according to claim 12 wherein the micro-particle is mounted on a cantilever.

16. A spectroscopic apparatus according to claim 12 wherein the light beam is configured to produce an optical tweezer effect which holds the micro-particle relative to the sample surface.

17. A spectroscopic apparatus according to claim 12 wherein the micro-particle has a size which is of the same order of magnitude as the illuminating wavelength.

18. A spectroscopic apparatus according to claim 12 wherein the micro-particle is a microsphere.

19. A spectroscopic apparatus according to claim 12 wherein the micro-particle comprises a dielectric material.

20. A spectroscopic apparatus according to claim 19 wherein the dielectric material is polystyrene.
